(19) United States
(12) Patent Application Publication
(10) Pub. No.: US 2014/0226313 A1
(43) Pub. Date: Aug. 14, 2014

(54) STRUCTURE OF LUMINOUS ROTARY CONTAINER

(71) Applicant: SHIU-CHENG YANG, Taoyuan County (TW)

(72) Inventor: SHIU-CHENG YANG, Taoyuan County (TW)

(21) Appl. No.: 13/962,950

(22) Filed: Aug. 8, 2013

(30) Foreign Application Priority Data
Feb. 8, 2013 (TW) 102105113

(51) Int. Cl. F21V 33/00

(52) U.S. Cl. CPC F21V 33/0036
USPC 362/101

(57) ABSTRACT

A container includes a receptacle, a stationary base, a rotating device, a power supply device, and an actuator. The receptacle receives a substance therein. The rotating device and the power supply device are arranged in the stationary base. The stationary base includes at least one light-emitting element. The rotating device drives the receptacle to rotate. The power supply device is electrically connected to the light-emitting element. The actuator extends into the stationary base and is reciprocally movable. The movement of the actuator drives the rotating device and actuates the power supply device. When a user pushes the actuator to cause the receptacle to rotate for providing effects of stirring and reducing temperature of the substance (such as liquid) received in the receptacle, the light-emitting element of the stationary base is also caused to generate and emit light to thereby achieve the advantages of enhancing interest, decoration, aesthetics, and practical utilization.

### TECHNICAL FIELD OF THE INVENTION

The present invention generally relates to a structure of a container, and more particularly to a structure of a luminous rotary container, which, when a receptacle thereof is caused to rotate for stirring a substance, also provides an effect of light emission so as to achieve the advantages of enhancing interest, decoration, aesthetics, and practical utilization.

### DESCRIPTION OF THE PRIOR ART

Modern people live in a busy and stressed manner and often desire to get themselves relaxed by for example enjoying a cup of drink in a coffee shop, a bar, or a teahouse. To create interior atmosphere, the coffee shop, bar, or teahouse is often decorated with dim and faint light. On the other hand, the cups or glasses used for drinking are often of unique appearance and outside configuration; however, no design has been made on the stirring function or lighting of the cups or glasses for the purposes of promotion or aesthetics. Thus, in such a dim and faint light, it is generally not possible to demonstrate the beauty and promotion effect of the design of the cups or glasses.

Known techniques related to lighting cups or glasses are shown in for example Taiwan Utility Model M298948, wherein two electrodes extending through the bottom of a container so that electrical conduction through a liquid is applied to conducting electrically between the two electrodes to achieve the purposes of light emission. However, the following disadvantages exist:

(1) Electricity conducted between the two electrodes is achieved through electrical conductivity through a liquid received in the container in order to light up the light source on the bottom of the container. If there is no liquid received in the container, there is no way to drive the light source to give off light. Thus, to enjoy the aesthetic effect provided by light projecting from the light source, the drink received in the container could not be drunk up. It is more desired to provide a more actively controllable way of controlling the light source to give off light.

(2) The electrodes are arranged to extend through the bottom of the container and must be set in contact with the liquid in order to achieve lighting. Thus, the joints between the two electrodes and the bottom of the container must be set in a tightly sealed condition in order to prevent the liquid received in the container from penetrating through the gaps to reach the electronic components set in the bottom of the container. If the assembly process fails to provide such a tight engagement, liquid can easily flow to the electronic components, leading to failure of the electronic components.

(3) As discussed in item (2), to allow the light from the light source set under the bottom of the container to transmit through the bottom of the container, the container must be made of a transparent material or a translucent material. When dirt is trapped in the gaps, it would be very unpleasant in the outside looking. Further, it is very easy that the residue of the drink that was previously received in the container to be trapped in the gaps when the container is cleaned. This causes serious concerns of hygiene.

The conventional lighting-included container or cup is generally imperfect and further improvement is desired.

The present invention aims to provide a solution to overcome such problems.

### SUMMARY OF THE INVENTION

An object of the present invention is to provide a structure of a rotary container that, through pushing of an actuator, causes a receptacle to rotate to apply a stirring effect on a substance and also provides a light generation effect for giving off light.

To achieve the above object, the present invention comprises a receptacle, a stationary base, a rotating device, a power supply device, and an actuator. The receptacle receives a substance to be stirred therein. The stationary base carries and supports the receptacle and defines therein a receiving space. The stationary base comprises at least a light-emitting element. The rotating device is arranged in the receiving space and the rotating device drives the receptacle to rotate. The power supply device is arranged in the receiving space. The power supply device is electrically connected to the light-emitting element. The actuator extends into the stationary base and is reciprocally movable. The movement of the actuator drives the rotating device and actuates the power supply device. Through pushing the actuator, the receptacle is caused to rotate so as to provide effects of stirring and temperature reduction of a substance (such as liquid) received in the receptacle and also causes the stationary base to generate an effect of light emission to thereby achieve the advantages of enhancing interest, decoration, aesthetics, and practical utilization.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is an exploded view of the present invention.

FIG. 3 is a plan view, in a sectioned form, showing a stationary base of the present invention.

FIG. 4 is a plan view, in a sectioned form, illustrating an operation of the present invention.

FIG. 5 is a perspective view illustrating an operation of the present invention.

FIG. 6 is a plan view, in a sectioned form, showing a stationary base according to another embodiment of the present invention.

FIG. 7 is a plan view, in a sectioned form, illustrating an operation of another embodiment of the present invention.

FIG. 8 is a perspective view illustrating an operation of another embodiment of the present invention.

FIG. 9 is an exploded view showing a power supply device according to another embodiment of the present invention.

FIG. 10 is a plan view, in a sectioned form, showing a power supply device according to another embodiment of the present invention.

FIG. 11 is a plan view, in a sectioned form, illustrating an operation of a power supply device according to another embodiment of the present invention.

FIG. 12 is a perspective view showing a light-emitting element according to another embodiment of the present invention.

FIG. 13 is a perspective view showing light-emitting elements according to a further embodiment of the present invention.

FIG. 14 is a plan view, in a sectioned form, showing a power generation assembly electrically connected to an electric accumulator according to an embodiment of the present invention.

FIG. 15 is a plan view, in a sectioned form, showing an actuator in direct engagement with a power supply device according to an embodiment of the present invention.

FIG. 16 is a plan view, in a sectioned form, showing a socket assembly provided for receiving a plug of an electronic device to plug therein according to an embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

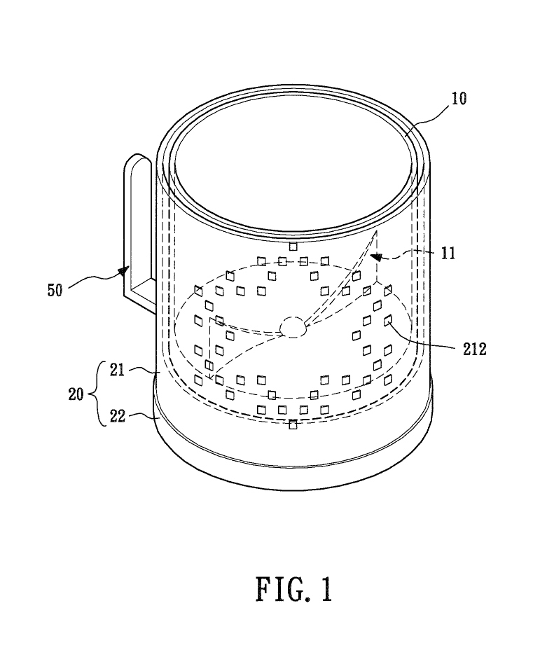

Referring to FIGS. 1, 2, and 5, a preferred embodiment of the present invention comprises a receptacle 10, a stationary base 20, a rotating device 30, a power supply device 40, and an actuator 50. Operation of the actuator 50 is applied to drive the receptacle 10 to rotate so as to provide effects of stirring and temperature reduction of a substance (such as liquid) received in the receptacle 10, while at the same time, the stationary base 20 is caused to simultaneously generate an effect of light emission to thereby achieve the advantages of enhancing interest, decoration, aesthetics, and practical utilization.

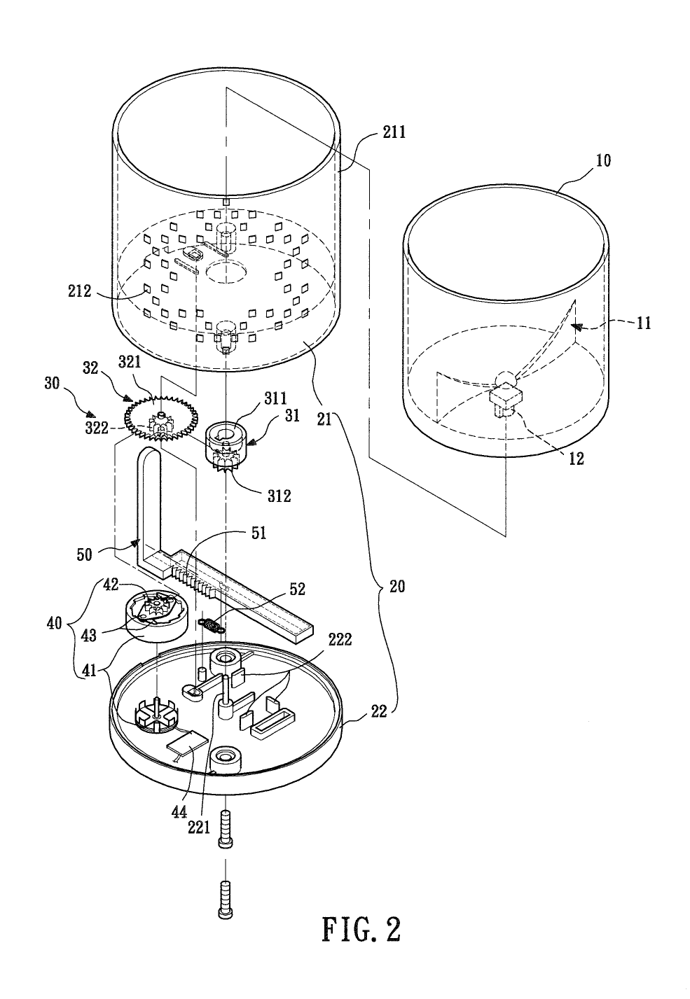

Referring to FIGS. 1 and 2, the receptacle 10 according to the present invention is provided for receiving and holding therein a substance, such as one of liquid, powder, and solid or a combination thereof. An inside bottom of the receptacle 10 is provided with a projecting blending member 11 for stirring and blending the substance. An outside bottom of the receptacle 10 is provided with an axle 12.

Referring to FIGS. 1 and 2, the stationary base 20 according to the present invention is provided for carrying and supporting the receptacle 10. The stationary base 20 comprises an enclosure 21 and a bottom board 22 and defines therein a receiving space. The enclosure 21 comprises a circumferential section 211 extending upward to a predetermined height to suitably enclose the receptacle 10 and to allow easy hand holding. The enclosure 21 has a surface on which a plurality of light-emitting elements 212, such as light-emitting diodes, is provided for emission of light. The light-emitting elements 212 may be arranged in a predetermined configuration to provide an effect of enhancing light emission and variation thereof.

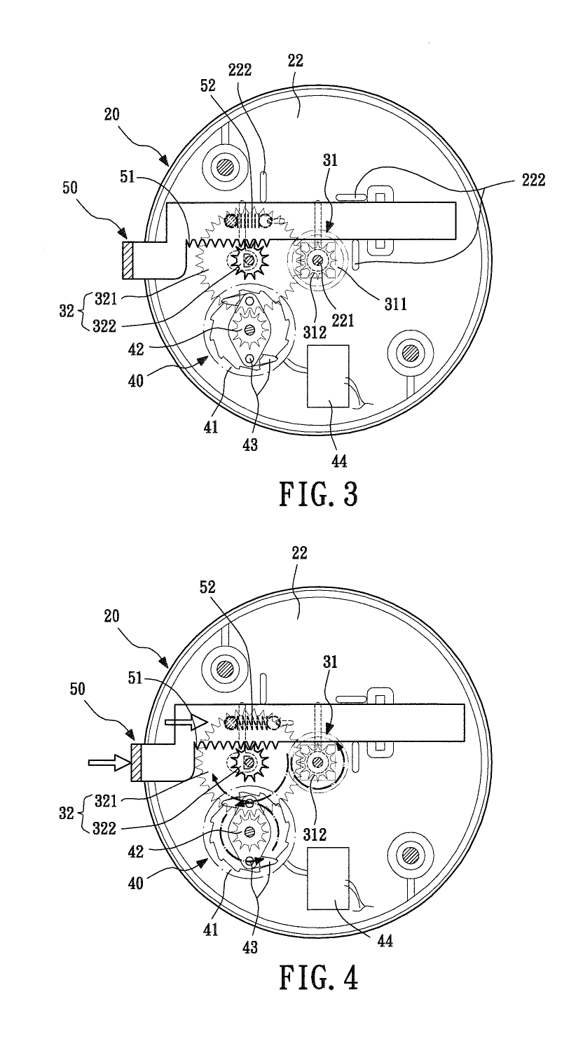

Referring to FIGS. 2 and 3, the rotating device 30 according to the present invention comprises a rotor 31 and a gear unit 32 that are rotatably mounted in the receiving space of the stationary base 20. The rotor 31 is rotatably mounted on a positioning peg 221 mounted on the bottom board 22. The rotor 31 comprises, in an upper portion thereof, a unidirectional rotation driving member 311, such as a one-way bearing, and the rotor 31 comprises, in a lower portion thereof, a pinion 312. The unidirectional rotation driving member 311 is coupled to the axle 12 so that the rotor 31 can drive the receptacle 10 to rotate in only one direction.

The gear unit 32 comprises a toothed disk 321 in an upper portion thereof and a transmission gear 322 in a lower portion thereof. The toothed disk 321 mates and is in driving coupling with the pinion 312.

The power supply device 40 is arranged in the stationary base 20. The power supply device 40 comprises a power generation assembly 41 that is rotatably mounted on the bottom board 22. The power generation assembly 41 can be a power generation device that, when driven, rotates to generate electrical power. The principle of power generation applied to the power generation assembly 41 is well known and detailed description thereof will be omitted therein. The power supply device 40 further comprises a toothed wheel 42 and a unidirectional rotation driving assembly 43. The toothed wheel 42 mates the toothed disk 321 for rotation in order to drive the underside unidirectional rotation driving assembly 43. In the instant embodiment, the unidirectional rotation driving assembly 43 comprises an assembly of a ratchet wheel and a driving pawl. The driving pawl is operatively coupled to the toothed wheel 42 and the ratchet wheel is mounted to the power generation assembly 41, whereby the toothed wheel 42 can drive, via the unidirectional rotation driving assembly 43, the power generation assembly 41 to rotate only in a predetermined direction. The power generation assembly 41 is electrically connected to a control circuit 44. The control circuit 44 is electrically connected to the light-emitting elements 212 to control functions of light emission of the light-emitting elements 212.

The actuator 50 is arranged to extend into the stationary base 20 and is guided by a plurality of guide sections 222 mounted on the bottom board 22 to do reciprocal movement. The actuator 50 comprises a toothed rack 51. The rack 51 mates and drives the transmission gear 322. The actuator 50 has an end that is exposed to be held by a user's hand for pulling or pushing.

An elastic element 52 is arranged in the receiving space of the stationary base 20. In the instant embodiment, the elastic element 52 comprises an extension spring. The elastic element 52 has an end fixed to the bottom board 22 and an opposite end fixed to the actuator 50, whereby the elastic element 52 provides a spring force for returning the actuator 50 when the actuator 50 is pushed and moved inward.

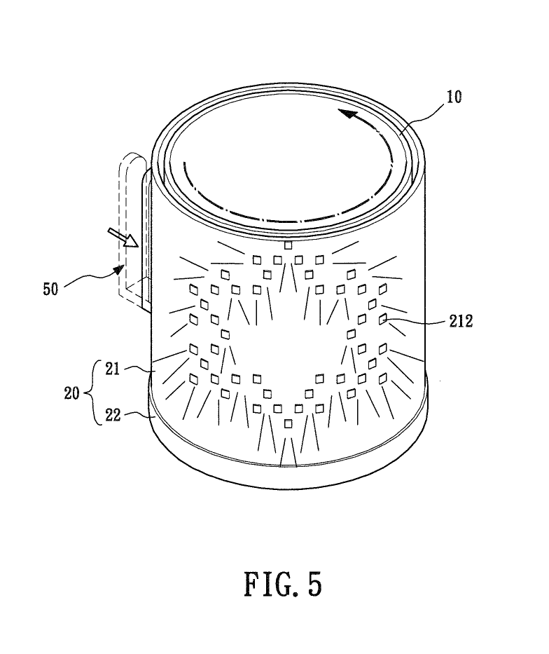

Referring to FIGS. 4 and 5, in an operation of the present invention, a substance to be stirred, such as liquid, is deposited in the receptacle 10 and the actuator 50 is held and pushed by a user's hand to cause the rack 51 to move and drive the transmission gear 322 to rotate, causing the toothed disk 321 and the pinion 312 to rotate, and finally causing the rotor 31 to rotate and drive the axle 12 that makes the receptacle 10 rotating simultaneously, whereby with the blending member 11 arranged in the receptacle 10, effects of stirring and causing air flow to reduce temperature of the substance (such as liquid) deposited in the receptacle 10 can be achieved.

After the actuator 50 is pushed to cause the receptacle 10 to rotate, in the process that the actuator 50 moves in the opposite direction to return to the original condition (namely moving in a direction toward the outside of the stationary base 20), due to the arrangement of the unidirectional rotation driving member 311 between the rotor 31 and the axle 12, the rotor 31 is no longer in operative coupling with the axle 12 and no resistance is induced therebetween, whereby the user can easily pull the actuator 50 for successive reciprocal movement thereof to maintain continuous rotation of he receptacle 10 and thus effectively and efficiently controlling the stirring speed of the receptacle 10.

Further, in the process of the actuator 50 returning back to the original condition (namely moving in a direction toward the outside of the stationary base 20), the axle 12 is not caused to rotate in the opposite direction so that the receptacle 10 can maintain rotation in the same direction.

When the rack 51 is moved to cause the toothed disk 321 to rotate, the toothed wheel 42 of the power supply device 40 is simultaneously caused to rotate and to drive, via the unidirectional rotation driving assembly 43, the power generation assembly 41 to rotate so that the power generation assembly 41 generates electrical power that is directly supplied to the light-emitting elements 212 of the enclosure 21 to make the light-emitting elements 212 emitting light. As such, advantages of enhancing interest of use and practicability can be achieved.

The function of the unidirectional rotation driving assembly 43 is to make the actuator 50 not driving the toothed wheel 42 to rotate in the opposite direction in the process that the actuator 50 is returning back to the original condition (namely moving in a direction toward the outside of the stationary base 20), whereby the power generation assembly 41 is allowed to maintain rotation in the same direction to facilitate power generation and supply of electrical power to the light-emitting elements 212.

The light-emitting elements 212 are controlled by the control circuit 44 to effect various lighting modes, such as continuous illumination, flashing, continuous illumination in part, flashing in part, alternating of different lighting modes, or random lighting.

The present invention takes advantage of power generated by the power generation assembly 41 to supply electrical power to the light-emitting elements 212, so that no electrical cell or battery or external power supply is needed and this provides an effectiveness of environment conservation.

Further, when the present invention is put into practice, if there is no need for the actuator 40, the rotor 31, and the power generation assembly 41 to maintain a high rotational speed ratio or if it is desired to simplify the structure for reduction of cost, the gear unit 32 can be omitted and the rack 51 can be put in direct and driving engagement with the pinion 312 and the toothed wheel 42 (this being not illustrated in the drawings).

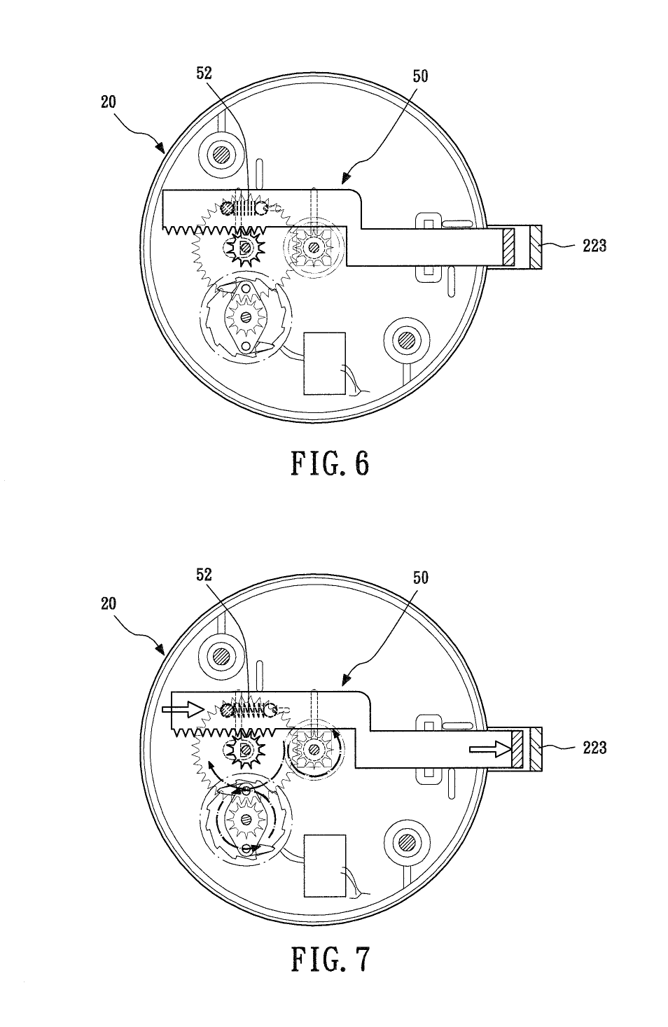

Referring to FIGS. 6, 7, and 8, another embodiment of the present invention is provided, which is operated by pulling the actuator 50 to drive the receptacle 10 to rotate and cause the light-emitting elements 212 to emit lights, wherein the bottom board 22 is provided with a hand-holding section 223 for being held by a user's hand and the actuator 50 is arranged to extend into the stationary base 20 in an opposite direction with the elastic element 52 being arranged to provide a spring force for position returning of the actuator 50 after the actuator 50 has been pulled and moved outward.

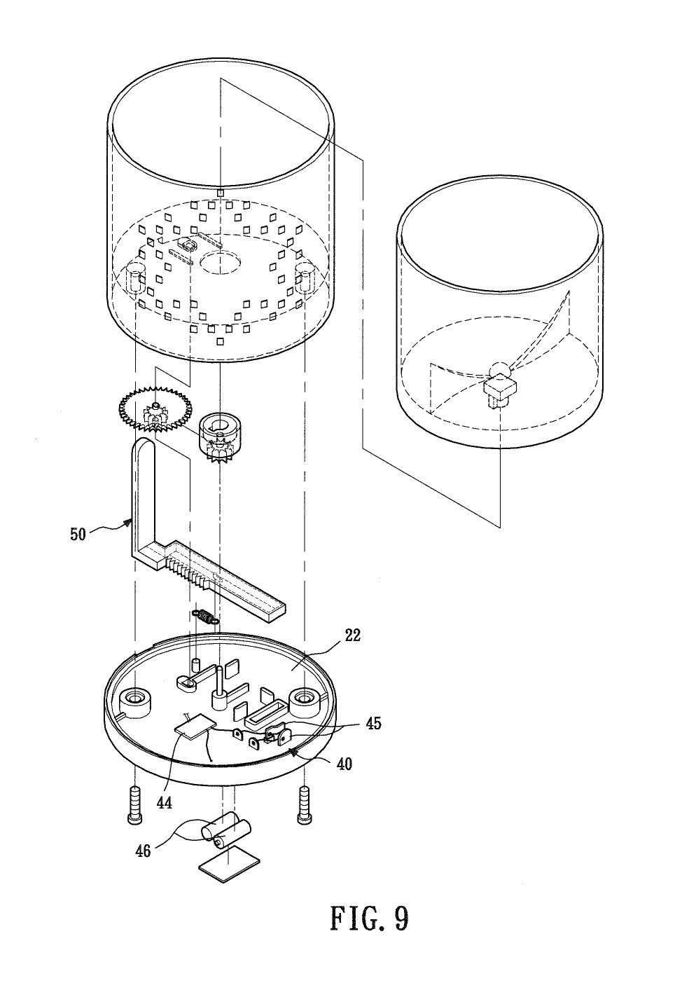

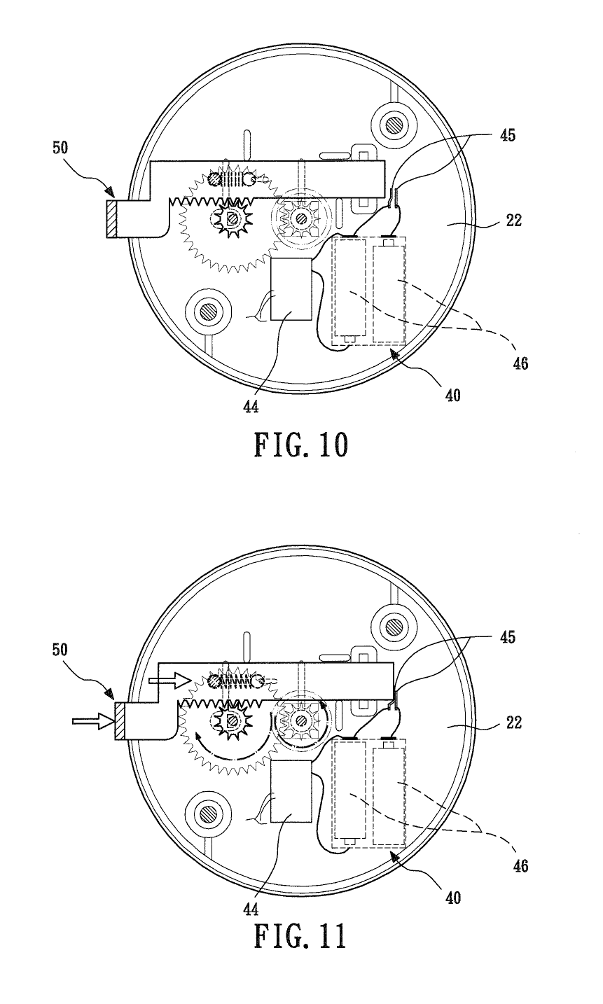

Referring to FIGS. 5, 9, 10, and 11, another embodiment of the power supply device 40 according to the present invention comprises a conductive contact plate assembly 45, a plurality of electrical cells 46, and a control circuit 44 that are electrically connected, wherein the conductive contact plate assembly 45, comprising conductive contact plates, is set at a predetermined location on the bottom board 22 in such a way that when the actuator 50 is not into operation, the conductive contact plate assembly 45 is kept in a non-engaging condition and when the actuator 50 is put into operation (namely moving in a direction toward the outside of the stationary base 20), the conductive plates of the conductive contact plate assembly are deformed by the actuator 50 to become an engaging condition whereby electrical power from the electrical cells 46 is allowed to supply to the light-emitting elements 212. The control circuit 44 is electrically connected to the light-emitting elements 212 to control the function of light emission of the light-emitting elements 212.

With such an arrangement, when the actuator 50 is operated to drive the receptacle 10 to rotate, the actuator 50 also contact and deform the conductive contact plate assembly 45 to make it contacting and conducting so as to allow the electrical cells 46 to supply electrical power to the light-emitting elements 212, making the light-emitting elements 212 generating and emitting light.

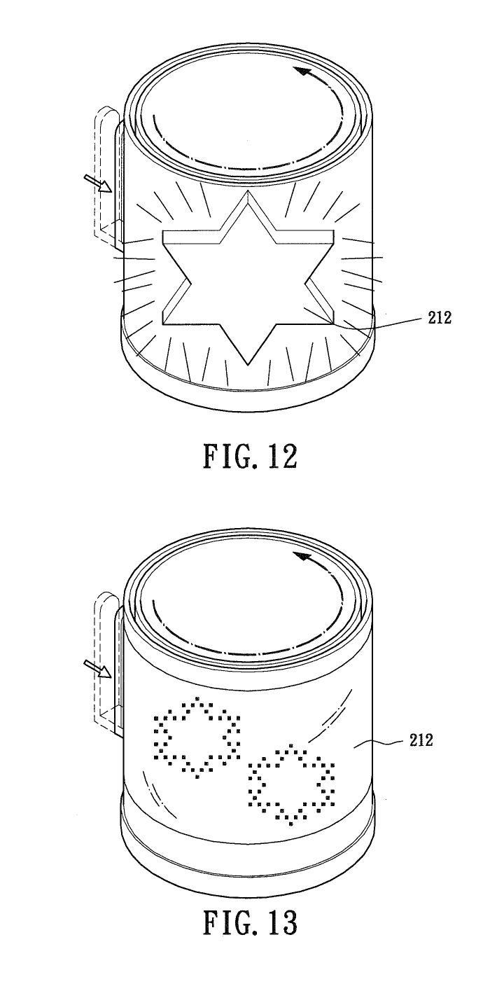

Referring to FIG. 12, the light-emitting elements 212 according to the present invention can be arranged in a three-dimensional configuration to enhance the effect of light emission and variation thereof and provide an effect of advertisement and promotion.

Referring to FIG. 13, the light-emitting elements 212 according to the present invention can be a liquid crystal light-emitting screen, such as a liquid crystal display or a luminescent panel, to allow the light-emitting elements 212 to provide one or a combination of the functions of light emission, text displaying, and pattern displaying to thereby enhance the effect of light emission and variation thereof and provide an effect of advertisement and promotion.

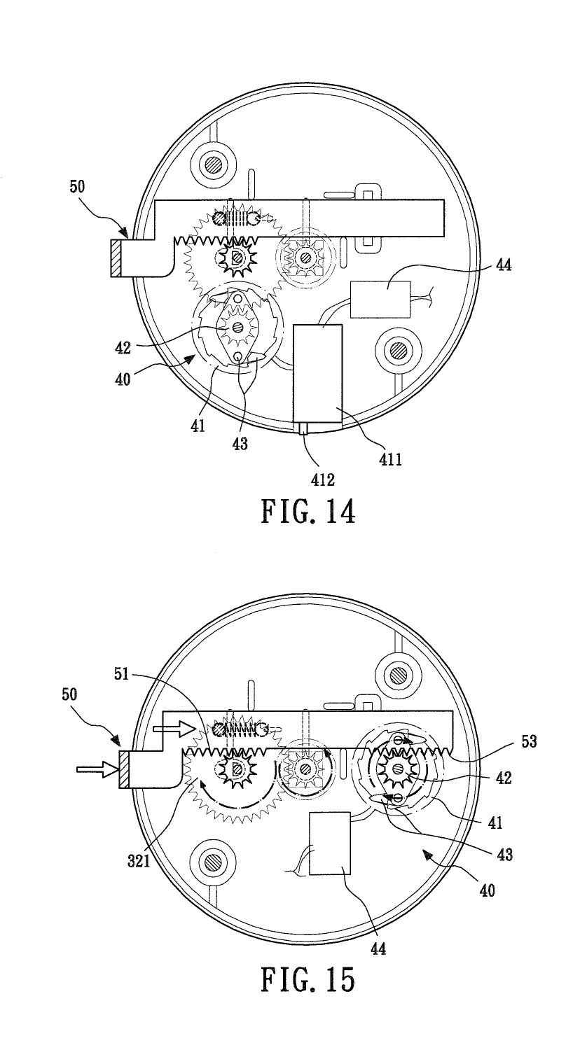

Referring to FIGS. 5 and 14, the power generation assembly 41 according to the present invention may be electrically connected to an electric accumulator 411 and the electric accumulator 411 is controlled by a switch 412 to supply or cut off electrical power supplied to the light-emitting elements 212.

With such an arrangement, when the power generation assembly 41 is put into operation, electrical power so generated thereby is partly supplied to the light-emitting elements 212 and is also partly stored in the electric accumulator 411 to allow a user, who does not operate the actuator 50, to operate the switch 412 for supplying electrical power from the electric accumulator 411 to the light-emitting elements 212, so that the light-emitting elements 212 are stilled energized to give off light.

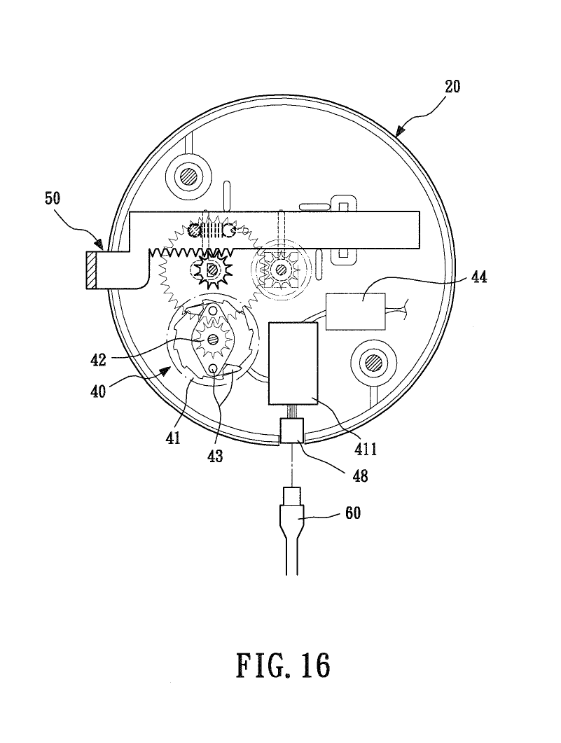

Referring to FIG. 16, the power supply device 40 according to the present invention may further comprise a socket assembly 48. The socket assembly 48 is mounted on the stationary base 20 and is electrically connected to the electric accumulator 411, whereby a plug of an electronic device 60 (such as a mobile phone, a tablet computer, a portable power supply, and the likes) can be plugged into the socket assembly 48 to allow the electrical power stored in the electric accumulator 411 to be supplied to the electronic device 60.

With such an arrangement, the present invention may serve as a temporary power supply, whereby an electronic device 60 owned by the user, when running out of power, can be charged by using the power supply device 40 of the present invention. As such, the convenience and practicability of use can be enhanced.

Referring to FIGS. 5 and 15, the actuator 50 according to the present invention can be arranged to directly mate the power supply device 40 with the toothed disk 321 omitted, where the actuator 50 comprises a further toothed rack 53 and the toothed wheel 42 of the power supply device 40 is set mating the rack 53 to be rotated thereby. As such, similar operations of rotating the receptacle 10 and making the light-emitting elements 212 emit light can be achieved.

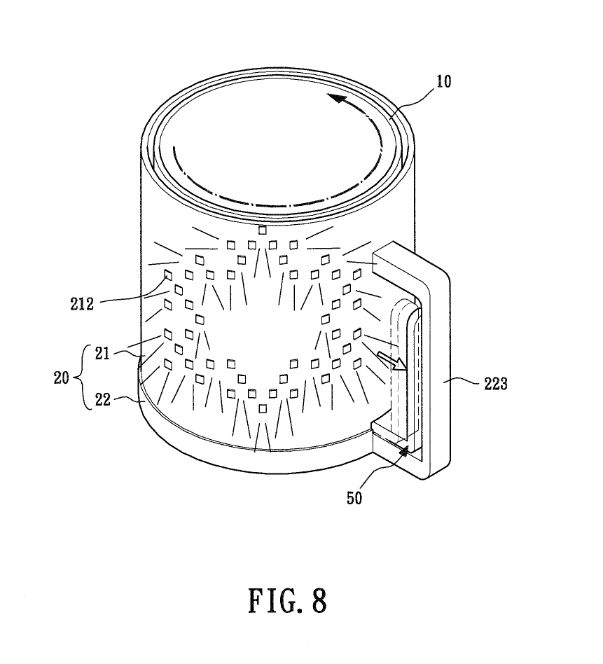

Referring to FIGS. 1 and 8, the enclosure 21 according to the present invention may be provided with a layer of transparent material, such as acrylic (not shown), on an outer surface thereof. The transparent material layer may comprise a plurality of recesses forming patterns or texts, whereby when the light-emitting elements 212 give off light, the light transmitting through the transparent material layer is subjected to guiding and condensation by the recesses to achieve an effect of luminous patterns or luminous texts.

Further, a light condensation and/or absorbing material, such as a fluorescent material or ink dot matrix, can be formed on the transparent material layer to show patterns or texts, so that when the light-emitting elements 212 give off light, an effect of luminous patterns or luminous texts can also be achieved.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A luminous rotary container, comprising:
a receptacle, which is adapted to receive a substance to be stirred therein;
a stationary base, which carries and supports the receptacle and defines therein a receiving space, the stationary base comprising at least a light-emitting element;
a rotating device, which is arranged in the receiving space, the rotating device driving the receptacle to rotate;
a power supply device, which is arranged in the receiving space, the power supply device being electrically connected to the light-emitting element; and
an actuator, which extends into the stationary base and is reciprocally movable, the movement of the actuator driving the rotating device and actuating the power supply device.

2. The luminous rotary container according to claim 1, wherein the stationary base comprises an enclosure and bottom board and forms the receiving space, the enclosure comprising a circumferential section that extends upward by a predetermined height.

3. The luminous rotary container according to claim 1, wherein the rotating device comprises a rotor rotatably arranged in the receiving space, the rotor comprising a unidirectional rotation driving member and a pinion, the unidirectional rotation driving member being coupled to a bottom of the receptacle in such a way that the rotor is allowed to drive the receptacle to rotate in only a predetermined direction, the actuator comprising a rack, the rack mating and driving the pinion.

4. The luminous rotary container according to claim 1, wherein the rotating device comprises a rotor and a gear unit rotatably arranged in the receiving space, the rotor comprising a unidirectional rotation driving member and a pinion, the unidirectional rotation driving member being coupled to a bottom of the receptacle in such a way that the rotor is allowed to drive the receptacle to rotate in only a predetermined direction, the gear unit comprising a toothed disk in an upper portion thereof and a transmission gear in a lower portion thereof, the toothed disk mating and operatively coupled to the pinion, the actuator comprising a rack, the rack mating and driving the toothed disk.

5. The luminous rotary container according to claim 1, wherein the power supply device comprises a power generation assembly rotatably arranged in the receiving space and a toothed wheel and a unidirectional rotation driving assembly, the toothed wheel being set in operative coupling with one of the rotating device and the actuator and being rotatable to drive the unidirectional rotation driving assembly, the unidirectional rotation driving assembly driving the toothed wheel the power generation assembly to rotate in a unidirectional rotation manner, the power generation assembly being electrically connected to and supplying electrical power to the light-emitting element.

6. The luminous rotary container according to claim 5, wherein the power generation assembly is electrically connected to a control circuit, the control circuit being electrically connected to the light-emitting element to control a lighting function of the light-emitting element.

7. The luminous rotary container according to claim 5, wherein the unidirectional rotation driving assembly comprises an assembly of a driving pawl and a ratchet wheel, the driving pawl being in operative coupling with the toothed wheel, the ratchet wheel being mounted to the power generation assembly, whereby the toothed wheel is allowed to drive, via the unidirectional rotation driving assembly, the power generation assembly to rotate in a unidirectional rotation manner.

8. The luminous rotary container according to claim 5, wherein the power generation assembly is electrically connected to an electric accumulator for storage of electrical power, the electric accumulator being controlled by a switch to selectively supply the electrical power to the light-emitting element.

9. The luminous rotary container according to claim 5, wherein the power generation assembly is electrically connected to an electric accumulator for storage of electrical power, the power supply device comprising a socket assembly, the socket assembly being mounted on the stationary base and electrically connected to the electric accumulator and adapted to receive a plug of an electronic device to be plugged therein so as to supply the electrical power from the electric accumulator to the electronic device.

10. The luminous rotary container according to claim 1, wherein the power supply device comprises a conductive contact plate assembly and a plurality of electrical cells that are electrically connected, the conductive contact plate assembly being arranged at a predetermined location in the receiving space in such a way that the conductive contact plate assembly is in a non-engaging and non-conducting condition when the actuator is not operated and is contacted to be in an engaging and conducting condition when the actuator is operated to allow the electrical cells to supply electrical power to the light-emitting element.

11. The luminous rotary container according to claim 10, wherein the power supply device comprises a control circuit, the control circuit being electrically connected to the light-emitting element and the electrical cells to control a lighting function of the light-emitting element.

12. The luminous rotary container according to claim 1, wherein the receptacle comprises at least one blending member therein for stirring and blending the substance.
